(19) United States
(12) Patent Application Publication
(10) Pub. No.: US 2011/0162557 A1
(43) Pub. Date: Jul. 7, 2011

(54) Solvent internal composition for thinning of uncured paint

(76) Inventors: Charles L. Hawes, Cordova, TN (US); Dennis E. Shireman, Marion, AR (US)

(21) Appl. No.: 12/655,664

(22) Filed: Jan. 4, 2010

(51) Int. Cl. C09D 7/12; C09K 3/00

(52) U.S. Cl. 106/285; 252/364

(57) ABSTRACT

A composition and related process for the thinning of uncured oil-based and uncured water-based paints, wherein the composition is a solvent internal emulsion which comprises a hydrocarbon solvent, a surfactant and water.

### TECHNICAL FIELD

The present invention relates to a solvent internal composition for thinning of uncured paint. In a more specific aspect, this invention relates to a paint thinning composition which is in the form of a solvent internal emulsion. This invention also relates to a process for thinning of uncured paint with a solvent internal composition.

In this application, the term “paint” will be understood to refer to oil-based and water-based pigmented coatings such as epoxies, enamels, latexes, primers, basecoats, oil based paints and unpigmented, varnishes and polyurethane finishes which are used to protect and/or beautify substrates. As used in this application, the terms “paint thinning”, “paint thinner” and similar terms refer to compositions which reduce the viscosity of paint by adding the paint thinner to uncured paint and then stirring this mixture before applying the thinned paint to a substrate.

In this application, the term “emulsion” will be understood to refer to a suspension of small globules or droplets of a liquid (solvent) in a second liquid in which the globules or droplets are not soluble. The emulsion of this application is a macroemulsion and can be described as solvent internal, in which the small globules or droplets (sometimes referred to as the internal phase; i.e., solvent) are suspended in a second or surrounding liquid (sometimes referred to as the external phase; i.e., water).

Also, in this application, the term “uncured paint” refers to paint in a liquid phase.

### BACKGROUND OF THE INVENTION

Compositions for thinning of paint are well-known in the industry, and many types of compositions exist for these particular uses.

Mineral spirits, a hydrocarbon solvent derived from crude oil, is perhaps the most commonly used paint thinner, especially for oil-based paint. Because of its direct relation to crude oil, mineral spirits is subject to fluctuations in the price of crude oil, such fluctuations often being upward.

Additionally, as local, state and federal governments require stricter controls on the amount of volatile organic compounds and combustible chemicals which can be used, the compositions used to thin paint often must be changed to comply with those controls.

Another commonly used paint thinner is turpentine. However, in contrast to turpentine, mineral spirits leaves no gummy residue, does not tend to deteriorate with age and is generally less expensive.

However, paint thinner compositions which are predominantly or entirely composed of mineral spirits or turpentine may create safety concerns, as these two materials are combustible.

Biodegradability may also be a concern for current paint thinner compositions which are predominantly or entirely composed of mineral spirits.

In addition, when working with paint thinner compositions, the user must also be concerned about the disposal of hazardous materials and the use of non-renewable resources. These two concerns are becoming more important as environmental issues become more significant.

The prior art contains many disclosures of compositions and methods which can be used to reduce the viscosity of certain compositions. For example, Bostrom et al. U.S. Pat. No. 6,150,445 discloses a composition and method for use in reducing the viscosity of an aqueous concentrate.

Sau U.S. Pat. No. 6,900,255 discloses a composition and method for suppressing (i.e., reducing) the viscosity in film forming coatings, such as latex paints.

In addition to disclosures in regard to viscosity reduction, the prior art discloses the use of emulsions in various industries. For example, Mulqueen et al. U.S. Pat. No. 6,074,986 discloses a composition and method for the preparation of emulsions in the cosmetic, pharmaceutical, food, photographic, paint and polymer industries.

Another disadvantage or undesirable result with prior art paint thinners is their tendency to adversely affect the physical or chemical properties of the cured paint which can be evident either before or after the thinned paint is applied to a substrate, both during the curing stage of the thinned paint and after the thinned paint is fully cured. Such properties include color, gloss, hardness, durability, etc.

Thus, for various reasons, the paint thinner compositions of the prior art do not achieve the results which are desired in many situations.

Therefore, there is a need in the industry for a paint thinner composition which eliminates or at least minimizes the disadvantages or problems encountered with the prior art compositions.

### SUMMARY OF THE INVENTION

The present invention provides an improved composition for thinning of uncured paint. As compared to the compositions of the prior art as described above, the composition of this invention is cost effective, contains less volatile organic compounds, does not substantially adversely affect the physical or chemical properties of the cured paint and reduces concerns in regard to safety and renewal of resources.

The present invention also provides a process for thinning of uncured paint.

Briefly described, the present invention provides a new and improved composition which is a solvent internal emulsion containing a hydrocarbon solvent, a surfactant and water. Each component is used in a defined weight percent range, based on the total weight of the composition.

The present invention describes the formulation of a solvent internal emulsion composition for thinning of uncured paint. In this composition, the water component is the external phase, and the hydrocarbon solvent is the internal phase present as very small droplets dispersed in the water component. The surfactant component of this composition is present at the interface of the external and internal phases.

Use of a solvent internal composition has certain advantages over other types of emulsions, specifically in regard to the thinning of uncured paint. The present solvent internal composition will incorporate into the paint much easier than other types of emulsions. Thus, the emulsion of this invention requires less mixing and provides less chance of a phase inversion to occur which can damage the liquid form of the paint and even cause the paint to be unusable.

Accordingly, an object of this invention is to provide a composition for thinning of uncured paint.

Another object of this invention is to provide a composition for thinning of uncured oil-based paint and uncured water-based paint.

Another object of this invention is to provide a paint thinner composition which contains a lower amount of volatile organic compounds.

Another object of this invention is to provide a paint thinner composition which provides less fuel to burn.

Another object of this invention is to provide a paint thinner composition which does not substantially adversely affect the physical or chemical properties of the cured paint.

Another object of this invention is to provide a paint thinner composition which is a solvent internal emulsion.

Still another object of this invention is to provide a process for thinning of uncured paint.

Still another object of this invention is to provide a process for thinning of uncured oil-based paint and uncured water-based paint.

Still another object of this invention is to provide a process for thinning of uncured paint with a composition which is a solvent internal emulsion.

These and other objects, features and advantages of the present invention will become apparent from the following description.

### DETAILED DESCRIPTION OF THE INVENTION

The present invention provides a composition, in the form of a solvent internal emulsion, for thinning of uncured paint, wherein the composition comprises a hydrocarbon solvent, a surfactant and water. The present invention also provides a process by which the above-defined solvent internal emulsion can be effectively used to thin uncured paint.

As defined above, there are certain essential components in the composition of this invention. These components and their corresponding weight percent ranges are shown below, with the weight percents being based on the total weight of the composition.

| Component | Weight Percent Range |
|---|---|
| Hydrocarbon Solvent | about 2.0 to about 50.0 |
| | (preferably about 20.0 to about 35.0) |
| Surfactant | about 0.01 to about 10.0 |
| | (preferably about 0.25 to about 2.0) |
| Water | about 40.0 to about 95.0 |
| | (preferably about 45.0 to about 80.0) |

If these components are used in amounts outside these ranges, the composition may provide results which do not meet the user's objectives for thinning of paint.

As well understood in this art, water will not reduce the viscosity of uncured oil-based alkyd point but, in most cases, will increase the viscosity of the uncured paint. Also well known is that a hydrocarbon solvent (such as mineral spirits) will not reduce the viscosity of uncured water-based latex paint but, in most cases, will increase the viscosity of the uncured paint.

In this invention, a unique composition has been developed in which water and a hydrocarbon solvent can be combined to effectively reduce the viscosity of both oil-based and water-based uncured paint, without substantial harm to the physical and chemical properties of the paint, whether uncured or cured. We believe the unexpected results of this invention are due at least in part to the composition being a solvent internal emulsion.

Optional components may be added to the composition of this invention to achieve other objectives. Examples of these optional components are preservatives, colorants, evaporation retardants, humectants, anti-settling agents, pigments, bittering agents, pH adjusting agents, etc. These optional components can be used in the amounts necessary to achieve desired results.

The solvent internal emulsion composition of this invention provides several advantages, a principal one being that the composition does not substantially adversely affect the physical or chemical properties of the paint. Examples of such properties are color, gloss, hardness, cure time, surface defects (such as wrinkles, pin holes and orange peels), durability (such as cracking, peeling and fading), abrasion resistance and resistance to chemical attack.

In this invention, the hydrocarbon solvent functions as the primary thinning component for uncured oil-based paint. Examples of suitable hydrocarbon solvents are aliphatic and aromatic hydrocarbons and mixtures of two or more of these solvents. The preferred hydrocarbon solvent is mineral spirits. Preferably, the hydrocarbon solvent contains from about 7 to about 18 carbon atoms.

Examples of suitable aliphatic and aromatic hydrocarbon solvents include terpenes, pine terpenes, raffimate solvents (aliphatic and aromatic), mineral spirits, kerosene, naptha, xylene, d-limonene, dipentene, turpentine, mineral seal oil, heptane and its isomers, Stoddard solvents, Rule 66 solvents, methyl cyclohexane, linear octadecane and its isomers, alkene hydrocarbons, toluene, alkylated benzenes (such as those available under the trade designations Aromatic 100 and Aromatic 150 solvents) and alkylated naphthalenes (such as heavy aromatic napthas).

The surfactant functions as a stabilizer to produce the emulsion and then to prevent separation of the emulsion into various components. Examples of suitable surfactants are nonionic surfactants, anionic surfactants, cationic surfactants, amphoteric surfactants and mixtures of such surfactants. The surfactant or surfactant mixture should be mixable in the solvent or solvent mixture and have an average surfactant HLB greater than about 5 and preferably greater than about 7.

Examples of suitable nonionic surfactants are:
alkoxylated alkyl phenols;
alkoxylated alcohols;
amines;
amides;
alkoxylated amides;
alkoxylated amines;
alkoxylated fatty acids;
alkoxylated thioethers;
glycerol esters;
sorbitan and alkoxylated sorbitan esters;
polygluconates;
silicone surfactants;
polymeric nonionic surfactants; and
ethylene oxide/propylene oxide block copolymers.

Examples of suitable cationic surfactants are:
alkyl trimethylammonium chlorides and bromides having from 12 to 22 carbon atoms and alkoxylated derivatives thereof;
dialkyl dimethylammonium chlorides and bromides having from 12 to 22 carbon atoms and alkoxylated derivatives thereof;
alkyl amine hydrochlorides and hydrobromides;
sulfates and sulfonates having from 12 to 22 carbon atoms and alkoxylated derivates thereof.

Examples of suitable anionic surfactants are:
acids and salts of alkyl sulfates and alkyl ether sulfates having from 12 to 30 carbon atoms;
acids and salts of alkylbenzene sulfonates having from 12 to 30 carbon atoms;
acids and salts of alkyldiphenyl oxides, sulfonates and disulfonates having from 12 to 30 carbon atoms;
acids and salts of alkyl naphthalene sulfonates having from 12 to 30 carbon atoms;
acids and salts of alkane or olefin sulfonates having from 10 to 20 carbon atoms;
acids and salts of ester sulfonates having from 12 to 20 carbon atoms;
acids and salts or various half salts of alkyl sulfosuccinates;
acids and salts of sulfobetaines;
acids and salts of phosphate esters;
acids and salts of saturated and unsaturated fatty acids having from 10 to 24 carbon atoms;
acids and salts of taurates and isothionates having from 12 to 24 carbon atoms.

Example of suitable amphoteric surfactants are:
amine oxides and betaines having from 10 to 20 carbon atoms;
alkyl imidazolines and imidazoline derivatives having from 10 to 24 carbon atoms;
acids and salts of alkylpropionates having from 10 to 24 carbon atoms;
acids and salts of alpha and beta alkyl aminoacid derivatives having from 10 to 24 carbon atoms;
alkyl substituted nitrogen heterocyclics having from 10 to 24 carbon atoms.

The water used in the composition of this invention can be deionized, soft, hard, sea water, tap, potable and non-potable water. Mixtures of such waters can be used.

The present invention is further illustrated by the following examples which are designed to teach those of ordinary skill in the art how to practice this invention and to represent the best mode contemplated for carrying out this invention.

### Procedure

The following solvent internal emulsions may be prepared using techniques and process steps which are well known in the industry. A preferred procedure to prepare the solvent internal emulsion compositions of Examples 1-10 is as follows: The hydrocarbon solvent and surfactant are mixed together in one container, and the water is stirred in another container. The mixture of hydrocarbon solvent and surfactant is then added to the water with continued stirring to form the solvent internal emulsions. Other procedures may be used to prepare the solvent internal emulsions of this invention.

### Example 1

| Component | Weight Percent |
|---|---|
| Water | 64.0 |
| *Aristonate L | 1.0 |
| Mineral Spirits | 35.0 |
| | 100.00 |

*a didodecylbenzene sodium sulfonate surfactant available from Pilot Chemical Company (Cincinnati, Ohio).

### Example 2

| Component | Weight Percent |
|---|---|
| Water | 63.0 |
| Oleic Acid Sodium Salt | 2.0 |
| Mineral Spirits | 35.0 |
| | 100.00 |

### Example 3

| Component | Weight Percent |
|---|---|
| Water | 63.5 |
| *Atlox 4913 | 1.5 |
| Mineral Spirits | 35.0 |
| | 100.00 |

*an acrylic graft copolymer surfactant available from Uniqema Corporation (New Castle, Delaware)

### Example 4

| Component | Weight Percent |
|---|---|
| Water | 63.0 |
| Dicocodimethyl Ammonium Chloride | 2.0 |
| Mineral Spirits | 35.0 |
| | 100.00 |

### Example 5

| Component | Weight Percent |
|---|---|
| Water | 64.0 |
| Cocoimidazoline | 1.0 |
| Mineral Spirits | 35.0 |
| | 100.00 |

### Example 6

| Component | Weight Percent |
|---|---|
| Water | 64.25 |
| *Aerosol TR-70 | 0.75 |
| Mineral Spirits | 35.0 |
| | 100.00 |

*a ditridecylsulfosuccinate sodium salt surfactant available from Cytec Industries, Inc. (West Paterson, New Jersey).

### Example 7

| Component | Weight Percent |
|---|---|
| Water | 64.25 |
| *Silsurf J208-612 | 0.75 |
| Mineral Spirits | 35.0 |
| | 100.00 |

*a silicone polyether surfactant available from Sil Tech, LLC (Dacula, Georgia).

### Example 8

| Component | Weight Percent |
|---|---|
| Water | 48.5 |
| Dodecylbenzene Sulfonic Acid | 0.5 |
| Octyldimethyl Amine | 1.0 |
| Mineral Spirits | 50.0 |
| | 100.00 |

### Example 9

| Component | Weight Percent |
|---|---|
| Water | 78.5 |
| Cocoamide | 1.5 |
| Mineral Spirits | 20.0 |
| | 100.00 |

### Example 10

| Component | Weight Percent |
|---|---|
| Water | 63.0 |
| 6 Mole Ethoxylated Tridecyl Alcohol | 2.0 |
| Mineral Spirits | 35.0 |
| | 100.00 |

TABLE 1

| | Farrell Calhoun uncured | Behr alkyd uncured |
|---|---|---|
| | water-based flat latex | oil-based enamel |
| 100% Paint | 3:40 | 3:34 |
| 15% Ex. 1 | 2:15 | 2:51 |
| 85% Paint | | |
| 15% Ex. 3 | 0:57 | 0:58 |
| 85% Paint | | |
| 15% Ex. 10 | 1:38 | 3:03 |
| 85% Paint | | |

The results shown in Table 1 are expressed in minutes and seconds. The numbers reflect the time a paint or paint composition takes to drain through a Ford #4 testing cup (by the ASTM D1200-94 method for viscosity). The results in Table 1 show that the solvent internal compositions of Examples 1, 3 and 10 provide improved thinning results, as the lower numbers indicate a thinned paint. Examples 1, 3 and 10 are indicative of the results which would be obtained with the remaining Examples 2 and 4-9.

In this application, the term “improved” is used to mean that a paint thinned with the composition of this invention provides better thinning results (i.e., less time to pass through a Ford #4 testing cup) than either unthinned paint or paint thinned with prior art thinning compositions.

The solvent internal emulsion compositions of this invention are effective in thinning uncured oil-based and water-based paints. This is surprising as the industry generally acknowledges that water will not thin oil-based paint, and a hydrocarbon solvent will not thin water-based paint. This invention provides a solvent internal emulsion composition which (a) contains a hydrocarbon solvent and water and (b) will thin uncured oil-based and water-based paints.

By using less solvent than conventional paint thinning and cleanup compositions, the solvent internal composition of this invention provides several advantages when compared to such conventional compositions:
In regard to safety - - - furnishes less fuel to burn if a fire should occur; and
In regard to disposal - - - provides less hazardous waste for disposal.

The solvent internal emulsion composition of this invention provides many other advantages and/or properties when compared to prior art thinning compositions. Examples of such advantages and/or properties include:
(a) The composition of this invention does not substantially adversely (or negatively) affect the quality of the thinned paint before that paint is applied to a substrate, such as by increasing the viscosity, causing flocculation of the paint or decreasing shelf stability.
(b) The chemical or physical properties of cured oil-based paint are not substantially adversely affected by thinning with the composition of this invention. Examples of such properties include:

1. Pencil Hardness, as measured by the ASTM D 3363-05 method, is not affected by more than 2 units.

The Pencil Hardness test has been used for many years in the industry to determine the hardness of clear and pigmented organic coatings. This test has also been used in the industry to determine the cure of these coatings, especially when these coatings are forced dried using heat.
2. Durability (for example, dry abrasion mar resistance as measured by the ASTM D 6037-96 method).
3. Gloss, as measured by the ASTM D 523-08 method, is not affected by more than 10 units.
4. Color, as measured by the ASTM D 523-08 method.
5. Resistance to Chemical Attack, as measured by the ASTM D 5402-06 method.

The present invention has been described in detail with particular reference to certain embodiments, but variations and modifications can be made without departing from the spirit and scope of the invention as defined in the following claims.

What is claimed is:

1. A solvent internal emulsion composition for thinning uncured paint, wherein the composition comprises:
A. from about 2.0 to about 50.0 percent by weight of a hydrocarbon solvent;
B. from about 0.01 to about 10.0 percent by weight of a surfactant; and
C. from about 40.0 to about 95.0 percent by weight of water.

2. A composition as defined by claim 1 wherein the hydrocarbon solvent is an aliphatic hydrocarbon, aromatic hydrocarbon or a mixture of two or more of these solvents.

3. A composition as defined by claim 1 wherein the hydrocarbon solvent is mineral spirits, kerosene, naptha, xylene, d-limonene, turpentine, dipentene or heavy aromatic naphtha.

4. A composition as defined by claim 1 wherein the hydrocarbon solvent is d-limonene.

5. A composition as defined by claim 1 wherein the hydrocarbon solvent is mineral spirits.

6. A composition as defined by claim 1 wherein the surfactant is a nonionic, anionic, cationic or amphoteric surfactant or a mixture of two or more of these surfactants.

7. A composition as defined by claim 1 wherein the surfactant is 6 mole ethoxylated tridecyl alcohol.

8. A composition as defined by claim 1 wherein the surfactant is coconut acid amide.

9. A composition as defined by claim 1 wherein the surfactant is coconut hydroxyethylimidazoline.

10. A composition as defined by claim 1 wherein the surfactant is a mixture of octyldimethylamine and dodecylbenzene sulfonic acid.

11. A composition as defined by claim 1 wherein the water is deionized water.

12. A solvent internal emulsion composition as defined by claim 1 wherein the uncured paint is an oil-based paint.

13. A solvent internal emulsion composition as defined by claim 1 wherein the uncured paint is a water-based paint.

14. A process for thinning of uncured paint, wherein the process comprises mixing the paint and a solvent internal emulsion composition which comprises:
A. from about 2.0 to about 50.0 percent by weight of a hydrocarbon solvent;
B. from about 0.01 to about 10.0 percent by weight of a surfactant; and
C. from about 40.0 to about 95.0 percent by weight of water;
and then stirring the mixture.

15. A process as defined by claim 14 wherein the hydrocarbon solvent is mineral spirits.

16. A process as defined by claim 14 wherein the hydrocarbon solvent is d-limonene.

17. A process as defined by claim 14 wherein the uncured paint is an oil-based paint.

18. A process as defined by claim 14 wherein the uncured paint is a water-based paint.

19. A process as defined by claim 14 wherein the solvent internal emulsion composition comprises:
A. from about 20.0 to about 35.0 percent by weight of a hydrocarbon solvent;
B. from about 0.25 to about 2.0 percent by weight of a surfactant; and
C. from about 45.0 to about 80.0 percent by weight of water.

20. A composition as defined by claim 1 wherein the solvent internal composition comprises:
A. from about 20.0 to about 35.0 percent by weight of a hydrocarbon solvent;
B. from about 0.25 to about 2.0 percent by weight of a surfactant; and
C. from about 45.0 to about 80.0 percent by weight of water.
